(19) United States
(12) Patent Application Publication
(10) Pub. No.: US 2026/0012123 A1
(43) Pub. Date: Jan. 8, 2026

(54) MULTIFUNCTIONAL ROOF COVERING WITH SOLAR ROOF TILES

(71) Applicant: paXos Solar GmbH, Langenfeld (DE)

(72) Inventor: Peter HAKENBERG, Solingen (DE)

(21) Appl. No.: 19/128,343

(22) PCT Filed: Nov. 10, 2023
(86) PCT No.: PCT/EP2023/081538

§ 371 Date: May 8, 2025

(30) Foreign Application Priority Data
Nov. 10, 2022 (DE) 10 2022 129 818.3

(51) Int. Cl. H02S 20/25; F24S 20/69; H02S 40/44

(52) U.S. Cl. CPC H02S 20/25; F24S 20/69; H02S 40/44

(57) ABSTRACT

A multifunctional roof covering for covering a roof of a building, wherein the roof covering has an outer side facing towards the surroundings and an inner side facing towards the interior of the building. Also related is a method for covering a roof of a building with at least one solar roof tile and for providing a multifunctional roof covering. Additionally related is an under-roof construction for the water-repellent sealing of a roof skin enveloping a building on the roof side and for providing at least one attachment unit for mounting at least one solar roof tile, and a method for preparing a roof of a building for covering with at least one solar roof tile.

### CROSS-REFERENCE TO RELATED APPLICATIONS

This application is a 35 U.S.C. § 371 National Stage patent application of PCT/EP2023/081538, filed on 10 Nov. 2023, which claims the benefit of German patent application no. 10 2022 129 818.3 filed on 10 Nov. 2022, the disclosures of which are incorporated herein by reference in their entirety.

### TECHNICAL FIELD

The present disclosure relates to a multifunctional building envelope part, in particular a multifunctional roof covering for covering a roof of a building. Furthermore, the disclosure relates to a method for cladding a building, in particular for covering a roof of a building, with at least one solar element, in particular at least one solar roof tile, and for providing a multifunctional building envelope part, in particular a multifunctional roof covering. In addition, the disclosure relates to an under-roof construction for the water-repellent sealing of a roof skin enveloping a building on the roof side and for providing at least one attachment unit for the mounting of at least one solar roof tile or a façade substructure for the water-repellent sealing of an outer skin which laterally envelops a building and for providing at least one attachment unit for mounting at least one solar element. In addition, the disclosure relates to a method for preparing a roof of a building for tiling with at least one solar roof tile or a method for preparing a façade of a building for cladding with at least one solar element. In principle, the multifunctional building envelope part can be a multifunctional façade for the lateral cladding of a building.

### BACKGROUND

Against the background of the energy turnaround and energy production with lower CO₂, many systems for decentralised energy generation are the already known. Thus, it is common to provide solar elements on the roof of a building for the purpose of using the thermal energy provided by solar radiation or also producing electrical energy in the form of electric current by means of photovoltaic technology (PV technology).). Basically, therefore, a multifunctional roof is provided, which not only serves for the protection of the interior of the building (for example against rainfall), but at the same time for the generation of energy.

On the one hand, there are installed solar energy modules or PV modules for this purpose, which are mounted by means of attachment structures on the existing roof, for example by drilling through existing roof tiles and providing them with attachment structures. A drawback with this, however, is that homeowners gain an embossed impression, since the solar or PV modules stand out visually against the neighbouring or underlying roof tiles, on the one hand due to the distinctly divergent geometry, but on the other hand because the attachment structures ensure that the solar or PV modules protrude against the base plane defined by the other tiles and are arranged in a higher plane. Amongst other things, such a projection from the “base plane of the tiles” frequently means, also for reasons connected with building regulations, that the entire roof surface is not provided with elevated solar and PV modules and the energy yield is less than possible.

A remedy is offered here by so-called solar roof tiles, which imitate the external appearance of a standard roof tile of the corresponding roof and in particular can be laid in the same plane with adjacent roof tiles. Whether it is for a roof which is completely occupied by solar roof tiles or for a roof which is occupied with several solar roof tiles, but which are to be arranged in the immediate vicinity of standard roof tiles.

### SUMMARY

The present disclosure seeks to make a contribution with regard to such systems which rely on solar roof tiles by making the systems less complex and more cost-effective and being able to take recourse to more standard components in production. Thus, it has hitherto been the case that, in particular, a primary function of roof tiles, i.e. that of the water-repellent sealing of the interior of the building, must as a matter of course be ensured by such solar roof tiles. For this purpose, complex structural measures are often provided on the know solar roof tiles. The laying of the corresponding systems on the roof also often proves to be expensive. Moreover, further systems from roof covering technology, such as for example the provision of potential equalisation and also the provision of storm suction protection, have to be adapted in an expensive way to the previously known solar roof tiles and frequently mounted separately on the roof.

Just as with the roof covering, the problems underlying the present disclosure can arise on a façade of a building. In this regard, it is also intended to simplify the provision of a multifunctional building envelope part, for example as a lateral façade of a building.

Against the background, a problem of the present disclosure is to provide a multifunctional building envelope part which enables uniform cladding implemented in a plane with the greatest possible occupancy for generating energy in a simple way. In particular, the aim is to provide a multifunctional roof covering for covering a roof of a building, which enables a uniform roof covering implemented in a plane with the greatest possible occupancy for generating energy in a straightforward manner. In particular, components that are easy to produce structurally should be able to be used to implement the multifunctional roof covering.

Furthermore, a problem of the disclosure is to propose a method that is as simple as possible for cladding a building with at least one solar element and for providing a multifunctional building envelope part. In particular, the aim is to propose a method that is as simple as possible for covering a roof of a building with at least one solar roof tile and for providing a multifunctional roof covering.

Furthermore, a problem of the disclosure is to propose an under-roof construction that is as simple as possible for the water-repellent sealing of a roof skin enveloping a building on the roof side and for providing at least one attachment unit for mounting at least one solar roof tile or a façade substructure that is as simple as possible for the water-repellent sealing of an outer skin enveloping a building on the sides and for providing at least one attachment unit for mounting at least one solar element.

Furthermore, a problem of the disclosure is to propose a method that is as simple as possible for preparing a roof of a building for covering with at least one solar roof tile or a method that is as simple as possible for preparing a façade of a building for cladding with at least one solar element.

The problem is solved with respect to a multifunctional building envelope part or a multifunctional roof covering by a multifunctional building envelope part or a multifunctional roof covering with the features of an independent claims. The problem is solved with respect to a method for cladding a building or covering a roof by a method for cladding a building or by a method for covering a roof of a building with at least one solar roof tile with the features of another independent claim. The problem is solved with respect to an under-roof construction or façade substructure by an under-roof construction for the water-repellent sealing of a roof skin enveloping a building on the roof side or a façade substructure for the water-repellent sealing of an outer skin laterally enveloping a building on the sides with the features of a further independent claim. The problem is solved with respect to a method for preparing a roof or a façade by a method for preparing a roof of a building for covering with at least one solar roof tile or by a method for preparing a façade of a building for cladding with at least one solar element with the features of a further independent claim.

In detail, a multifunctional building envelope part is proposed or a multifunctional roof covering for covering a roof of a building is proposed, wherein the multifunctional building envelope part, in particular the roof covering, comprises an outer side facing the surroundings and an inner side facing the interior of the building. The inner side is designed as a dimensionally stable, preferably sheet-like, body for the water-repellent sealing of an outer skin enveloping the building, or a roof skin enveloping the building on the roof side, and for mounting on the outer skin or the roof skin. The dimensionally stable, preferably sheet-like body comprises a body outer side facing in the direction of the surroundings and is designed for mounting on the outer skin or roof skin. The dimensionally stable, preferably sheet-like body comprises at least two elevations extending further to the body outer side. In addition, at least one attachment unit with an attachment unit inner side is fixedly mounted on the at least two elevations on the body outer side. The attachment unit comprises an outer leg spaced apart from the attachment unit inner side in the direction of an attachment unit outer side and extending in the direction of a top-side or roof ridge-side attachment unit end. The outer side of the building envelope part or roof covering is equipped uniformly with at least one solar element or solar roof tile in such a way that the at least one solar element or the at least one solar roof tile, in combination with other adjacent solar elements or solar roof tiles and/or adjacent standard plate elements or roof tiles, forms the outer side of the building envelope part or roof covering substantially in a common plane, in particular a tile plane, whereby the at least one solar element or the at least one solar roof tile engages behind the outer leg of the attachment unit with a rear hook portion in a form-fitting manner.

Furthermore, a method for cladding a building with at least one solar element and for providing a multifunctional building envelope part or a method for covering a roof of a building with at least one solar roof tile and for providing a multifunctional roof covering is proposed with the following steps:
a) providing an inner side of the roof covering facing the interior of the building as a dimensionally stable, preferably sheet-like body for the water-repellent sealing of a roof skin enveloping the building on the roof side (or providing an inner side of the building envelope part facing the interior of the building as a dimensionally stable body for the water-repellent sealing of an outer skin enveloping the building), and thus providing a body outer side facing in the direction of the surroundings and at least two elevations of the dimensionally stable, preferably sheet-like body which extend further towards the body outer side.
b) mounting at least one attachment unit on the body outer side of the dimensionally stable, preferably sheet-like body, by fixedly mounting an attachment unit inner side on the at least two elevations, and thereby providing an outer leg of the attachment unit, which is spaced apart from the attachment unit inner side in the direction of the attachment unit outer side and extends in the direction of a top-side or roof ridge-side attachment unit end.
c) covering the roof with the at least one solar roof tile (or cladding the outer enclosure with the least one solar element), whereby the at least one solar roof tile (or the at least one solar element) is engaged from the rear with a rear hook portion in a form-fitting manner with the outer leg of the attachment unit and the at least one solar roof tile (or the at least one solar element) forms, in combination with further adjacent solar roof tiles (or solar elements) and/or adjacent standard roof tiles (or standard plate elements), an outer side of the roof covering (or the building envelopment part) essentially uniformly in a common plane, in particular a tile plane.

In particular, it is possible with the described, proposed method to provide a previously described, proposed multifunctional roof covering to cover a roof (or with the method for cladding a building to provide a multifunctional building envelope part).

Furthermore, an under-roof construction or façade substructure for the water-repellent sealing of a roof skin enveloping a building on the roof side or outer skin enveloping a building at the sides, and for providing at least one attachment unit for mounting at least one solar roof tile or solar element is proposed. The under-roof construction or façade substructure comprises a dimensionally stable, preferably sheet-like body for the water-repellent sealing of the roof skin or outer skin, and the under-roof construction or façade substructure comprises a dimensionally stable, preferably sheet-like body for the water-repellent sealing of the roof skin or outer skin, and the under-roof construction or façade substructure comprises the attachment unit. The dimensionally stable, preferably sheet-like body comprises a body outer side pointing in the direction of the surroundings and is designed to be mounted on the roof skin or outer skin. The dimensionally stable, preferably sheet-like body comprises at least two elevations extending further to the outside of the body. The attachment unit is fixedly mounted with an attachment unit inner side on the at least two elevations on the body outer side. The attachment unit additionally comprises an outer leg, which is spaced apart from the attachment unit inner side in the direction of an attachment unit outer side and extends in the direction of a roof ridge-side or top-side attachment unit end, for the form-fitting connection of at least one solar roof tile or solar element.

Finally, a method for preparing a roof of a building for covering with at least one solar roof tile or a method for preparing a façade of a building for cladding with at least one solar element is proposed with the following steps:
a) applying a dimensionally stable, preferably sheet-like body for water-repellent sealing on the roof skin enveloping the building on the roof side or an outer skin enveloping the building, and thereby providing a body outer side facing in the direction of the surroundings and at least two elevations of the dimensionally stable, preferably sheet-like body extending further to the body outer side; and
b) mounting at least one attachment unit on the body outer side of the dimensionally stable, preferably sheet-like body, by mounting an attachment unit inner side fixedly on the at least two elevations, and thereby providing an outer leg of the attachment unit, which is spaced apart from the attachment unit inner side in the direction of attachment unit outer side and extends in the direction of a roof ridge-side or top-side attachment unit end, for the form-fitting connection of at least one solar roof tile or solar element by engaging the at least one solar roof tile or solar element with a rear hook portion.

In particular, it is possible with the described proposed method to provide a previously described, proposed under-roof construction for preparing a roof (or possible with the method to provide a previously described proposed façade substructure for preparing a façade ). In particular, it is possible with the described proposed method to provide a previously described proposed multifunctional roof covering to prepare for a roof (or possible with the method to provide a multifunctional building envelope part in the form of a multifunctional façade for preparing a façade ).

Further advantageous embodiments can be deduced from the following description and in particular the figures and the description thereof.

The present disclosure has the essential advantage that the two functionalities which are to be fulfilled in principle, on the one hand the water-sealing of the roof and on the other hand also the energy recovery when using solar roof tiles, can be implemented via two part-systems which are spatially separated from one another, and these part-systems can be mounted separately in a simple manner one after the other. Thus, the dimensionally stable, preferably sheet-like body ensures the sealing of the roof skin. The proposed attachment units which can be produced and mounted separately from the body then ensure the provision of an attachment structure for solar roof tiles flat on the dimensionally stable, preferably sheet-like body sealing the roof. The entire roof surface can then, if desired, be covered with solar roof tiles in a common uniform plane in a simple manner, or solar roof tiles can also be laid together with standard roof tiles, but advantageously also visually in a common plane.

These advantages also apply with respect to the cladding of a façade (for short façade cladding). Thus, the façades can also be designed to be multifunctional at the side of a building and provided with solar elements, in order to provide on the building façade, for example, on the one hand thermal energy recovery and on the other hand electrical energy generation via the PV element. The present disclosure can provide a solution here, since a uniform and dense façade plane can be provided via the separate elements of the dimensionally stable, preferably sheet-like body, as well as the attachment unit, as well as the final solar elements. Advantageously, the corresponding façade system can be mounted on the one hand on the existing building façades, but on the other hand can also be used in the context of new buildings or building refurbishment in the form of thermal insulation of building façades; thus, the proposed system can ensure through the water-repellent, dense components of the dimensionally stable body that the underlying elements and building materials of the building façade are sealed just to the exterior. Plastering, painting, other lining of the building façade possibly provided with thermal insulation, can then be dispensed with. In the present case, a façade cladding or a method for cladding a façade can be understood to mean that the façade of the building is not entirely, but only partially lined with the proposed system.

In the present case, a dimensionally stable body is to be understood to mean that, for example, fabric webs or suchlike, as very flexible and thus non-dimensionally stable layers even at usual ambient temperatures, are not to be used for sealing the roof skin or the outer skin (lateral façade of the building).

In the present case, a body that is present sheet-like is to be understood in a similar way to the property of dimensionally stable, that is a solid body in the inner side of the roof covering (or of the building envelope part, i.e. also the façade cladding), such as is the case for example with a sheet metal, which is dimensionally stable and solid at the usual temperatures in use. In particular, the body is a sheet-like body around a thin material, but in contrast to fabric webs, for example, is rigid material.

Laying of the inner side of the roof covering on the roof can accordingly take place by applying and positioning the dimensionally stable sheet-like inner side, for example by adding sections of the inner side, i.e. of the dimensionally stable sheet-like body, on the roof skin and then joining these sections with one another to form a common unit, in particular sealing the roof skin as a solid body.

According to an embodiment of the multifunctional building envelope part, in particular of the multifunctional roof covering, provision can be made such that a cavity is formed between the two elevations, in such a way that in the cavity an air flow flowing along in the direction of the top-side end, in particular the roof ridge-side end and below a solar element inner side, in particular a solar roof tile inner side, is formed.

According to an embodiment of the multifunctional building envelope part, in particular of the multifunctional roof covering, provision can be made such that the attachment unit is designed as a top-hat rail. In particular, the top-hat rail can be arranged under solar element/solar roof tiles, can engage over and support a plurality of horizontal adjacent solar elements/solar roof tiles or support or serve as an attachment unit for the latter.

According to an embodiment of the multifunctional building envelope part, in particular of the multifunctional roof covering, provision can be made such that the attachment unit comprises a further outer leg spaced apart from the attachment unit inner side in the direction of an attachment unit outer side, wherein this further outer leg extends in the direction of an underside, in particular a roof eaves-side attachment unit end.

According to an embodiment of the multifunctional building envelope part, in particular of the multifunctional roof covering, provision can be made such that the outer leg extending in the direction of the top-side, in particular roof-ridge side, attachment unit end is spaced farther from the attachment unit inner side than the outer leg extending in the direction of the underside, in particular roof-eaves side, attachment unit end. An overlapping arrangement on the attachment unit of applied and vertically adjacent solar elements/solar roof tiles can thus be implemented more easily.

According to an embodiment of the multifunctional building envelope part, in particular of the multifunctional roof covering, provision can be made such that, viewed vertically, an underlying adjacent solar element or plate element or, viewed vertically, an underlying adjacent solar roof tile or standard roof tile lies on the face, pointing in the direction of the attachment unit outer side, of the outer leg extending in the direction of the underside, in particular roof eaves-side attachment end.

According to an embodiment of the multifunctional building envelope part, in particular of the multifunctional roof covering, provision can be made such that the attachment unit provides a receiving space between the inner leg and the at least one solar element, in particular the at least one solar roof tile, as well as vertically adjacent elements. Cabling of the at least one solar element, in particular of the at least one solar roof tile, and optionally at least one adjacent solar element, in particular solar roof tile, can be arranged in the receiving space. In particular horizontally adjacent solar elements/solar roof tiles can be cabled together via the receiving space.

According to an embodiment of the multifunctional building envelope part, in particular the multifunctional roof covering, provision can be made such that in one, preferably both connecting section (or connecting sections) spacing the inner leg apart from the outer leg (or the outer legs), at least one through-ventilation opening (preferably a plurality) is arranged for partially conducting the air flow. “Spaced apart” is understood to mean that, in principle, the outer leg has a certain distance from the inner leg via the connecting section.

According to an embodiment of the multifunctional building envelope part, in particular of the multifunctional roof covering, provision can be made such that at least one outlet opening for draining water from a/the receiving space is provided in a transition region between the inner leg and a/the connecting section, which is assigned to a/the attachment unit end (preferably on the roof-eaves side). In particular, the electrical components, if appropriate to be arranged precisely in the receiving space, are securely protected.

According to an embodiment of the multifunctional building envelope part, in particular the multifunctional roof covering, provision can be made such that the attachment unit, as viewed in a vertical row of two adjacent solar elements, preferably solar roof tiles, is arranged engaging over the solar element/solar roof tile arranged below and the solar element/solar roof tile arranged above and beneath the two vertically adjacent solar elements/solar roof tiles. Alternatively or in addition, a/the solar element/solar roof tile arranged above can also rest with its underside solar element end or roof eaves-side solar roof tile end on a/the upper-side solar element end or roof ridge-side solar roof tile end of a/the solar element/solar roof tile arranged below.

According to an embodiment of the multifunctional building envelope part, in particular of the multifunctional roof covering, provision can be made such that the rear hook portion comprises an outer leg extending as far as a/the underside solar element end, in particular the roof eaves-side solar roof tile end. A direct contact between glass stacks of vertically directly adjacent solar elements/solar roof tiles can preferably also thus be avoided.

According to an embodiment of the multifunctional building envelope part, in particular of the multifunctional roof covering, provision can be made such that the rear hook portion comprises a front leg which engages around and protects a front surface of the solar element (in particular solar roof tile), which front surface is arranged on a/the underside solar element end, in particular a roof eaves-side solar roof tile end. The front leg can preferably terminate on a/the solar element outer side, in particular a solar roof tile outer side, flush with the solar element, in particular solar roof tile.

Furthermore, according to an independent aspect of the present disclosure, a method for dismantling a single solar element to be dismantled, preferably a solar roof tile, from a composite of at least vertically adjacent solar elements, in particular solar roof tiles, is also proposed. The single solar element to be dismantled, preferably solar roof tile, is first displaced partially upwards in the direction of the building roof or roof ridge. This is preferably carried out by the top-side solar element end, in particular the roof ridge-side solar roof tile end, being displaced upwards in a free space below the solar element, preferably solar roof tile, and a rear hook portion is thereby brought out of engagement with an attachment unit. According to the proposal, an underside solar element end, in particular a roof eaves-side solar roof tile end, is then pivoted forward away from the composite and the single solar element to be dismantled, preferably solar roof tile, is pulled away downwards and thus released from the composite. If appropriate, it is previously necessary to release cabling or a plurality of cables.

Analogously in the quasi-reverse order, a method for mounting a single solar element/solar roof tile into an already existing composite in which only one space is free can also be carried out, which method for dismantling represents a further independent inventive aspect of the present application.

According to an independent aspect of the present disclosure, a multifunctional building envelope part, in particular a multifunctional roof covering for covering a roof of a building or a multifunctional façade cladding, is also proposed. The multifunctional building envelope part, in particular the roof covering or façade cladding, comprises an outer side facing the surroundings and an inner side facing the interior of the building. Furthermore, at least one attachment unit with an attachment unit inner side is fixedly mounted on an outer skin enveloping the building, in particular a roof skin enveloping the building on the roof side or a lateral outer skin of the building. Furthermore, the attachment unit comprises an outer leg which is spaced apart from the attachment unit inner side in the direction of an attachment unit outer side and extends in the direction of a top-side, in particular roof-ridge side, attachment unit end. Furthermore, the outer side is uniformly equipped with at least one solar element, in particular a solar roof tile, in such a way that the at least one solar element, in particular the at least one solar roof tile, in combination with further adjacent solar elements, in particular solar roof tiles, and/or adjacent standard plate elements, in particular roof tiles, forms the outer side of the building envelope part, in particular the roof covering or façade cladding, substantially in a common plane, whereby the at least one solar element, in particular the at least one solar roof tile, engages behind the outer leg of the attachment unit in a form-fitting manner with a rear hook portion. The attachment unit between an inner leg and the at least one solar element, in particular the at least one solar roof tile, and a vertically adjacent solar element, in particular solar roof tile, provides a receiving space, wherein cabling of the at least one solar element, in particular of the at least one solar roof tile, and optionally at least one adjacent solar element, in particular solar roof tile, can be arranged in the receiving space separately from the outer skin, in particular roof skin or a lateral outer skin of the building. In this proposed embodiment, a dimensionally stable, preferably sheet-like body is then no longer provided between the attachment unit(s) or solar roof tiles(s) and the underlying roof skin/outer skin. Thus, the sensitive electrical components (cabling) to be protected by the roof skin (outer skin) or the area of the building lying farther inside can be arranged in the receiving space of the attachment unit in a particularly protected manner. For this purpose, it is advantageous if the attachment unit is designed as a hat-rail and this receiving space is formed in the interior of the hat-rail.

In principle, embodiments according to the present disclosure are described jointly if possible. Features described only in connection with the multifunctional roof covering (or the multifunctional building enclosure part) or the under-roof construction (or façade substructure) can, in a technically meaningful manner, also be transferred to the respective other category of claims and form independent embodiments of the present disclosure. The same applies analogously to the methods described in accordance with the present disclosure, on the one hand for covering a roof of a building with at least one solar roof tile (or for cladding a building) and on the other hand methods for preparing a roof of a building for covering with at least one solar roof tile (or for preparing a façade of a building), and further concerning the claims categories of the described devices or systems and methods.

In particular, the multifunctional roof covering according to the present disclosure can comprise the under-roof construction according to the present disclosure, or a multifunctional building envelope part in the form of a multifunctional façade cladding according to the present disclosure can comprise the façade substructure according to the present disclosure.

### BRIEF DESCRIPTION OF THE DRAWINGS

Further advantageous and preferred embodiments emerge from the following description with reference to the figures. In the drawing reproducing just one example of embodiment:

FIG. 1 shows a diagrammatic oblique front view of a section of a multifunctional roof covering according to the present disclosure,

FIG. 2 shows a diagrammatic cross-sectional side view from one side of the multifunctional roof covering of FIG. 1,

FIG. 3 shows, according to view a), detail A from FIG. 2 in an enlarged illustration, and according to view b) an attachment unit of a multifunctional roof covering according to the present disclosure in an isolated side view, and according to view c) a rear hook portion of a solar roof tile of a multifunctional roof covering according to the present disclosure in an isolated side view,

FIG. 4 shows detail B from FIG. 2 in an enlarged illustration,

FIG. 5 shows, according to view a), a diagrammatic cross-sectional view from below onto or into the multifunctional roof covering of FIG. 1 corresponding to viewing direction x in FIG. 1, and according to view b) detail C from view a) of FIG. 5 in an enlarged illustration,

FIG. 6 shows, according to view a), a diagrammatic oblique front view of a section of a further multifunctional roof covering according to the present disclosure, and according to view b) a diagrammatic front view of this section of this further multifunctional roof covering from view a) of FIG. 6,

FIG. 7 shows a diagrammatic cross-sectional side view from one side of the multifunctional roof covering of FIG. 6,

FIG. 8 shows detail D from FIG. 7 in an enlarged illustration,

FIG. 9 shows a further rear hook portion of a solar roof tile of a multifunctional roof covering according to the present disclosure in an isolated side view,

FIG. 10 shows detail G from FIG. 7 in an enlarged illustration,

FIG. 11 shows a further embodiment of an attachment unit (hat-rail),

FIG. 12 shows the attachment unit (hat-rail) according to FIG. 11 in a perspective view,

FIG. 13 shows the attachment unit (hat-rail) according to FIG. 11 in a front view,

FIG. 14 shows the attachment unit (hat-rail) according to FIG. 11 in a plan view,

FIG. 15 shows a further embodiment of a roof covering or façade cladding in a partial view from the side,

FIG. 16 shows the roof covering or façade cladding in FIG. 15 in a partial view in a perspective view, and

FIG. 17 shows a further embodiment of a rear hook portion.

### DETAILED DESCRIPTION OF THE DRAWINGS

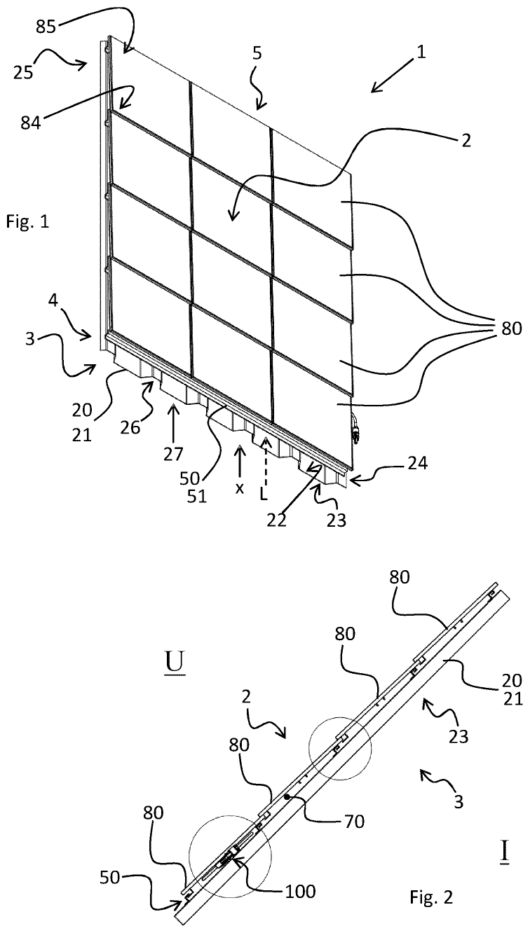

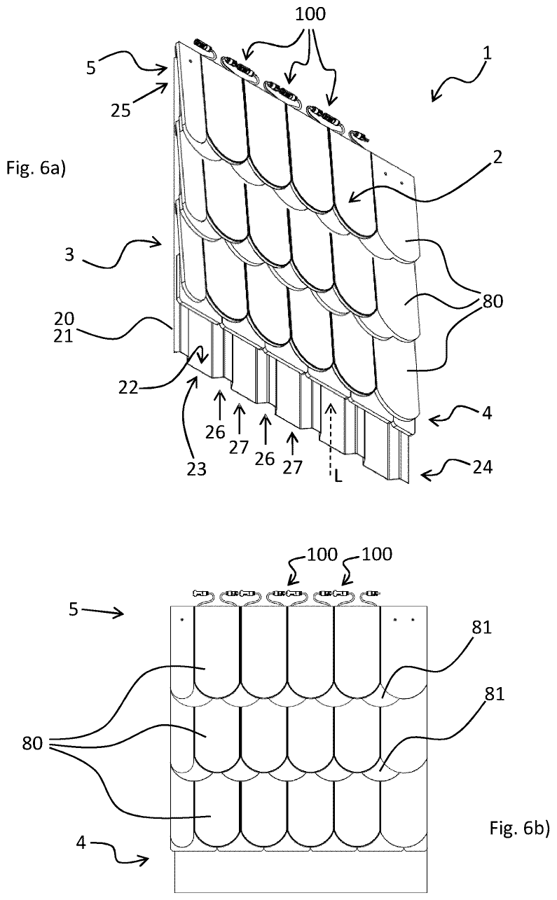

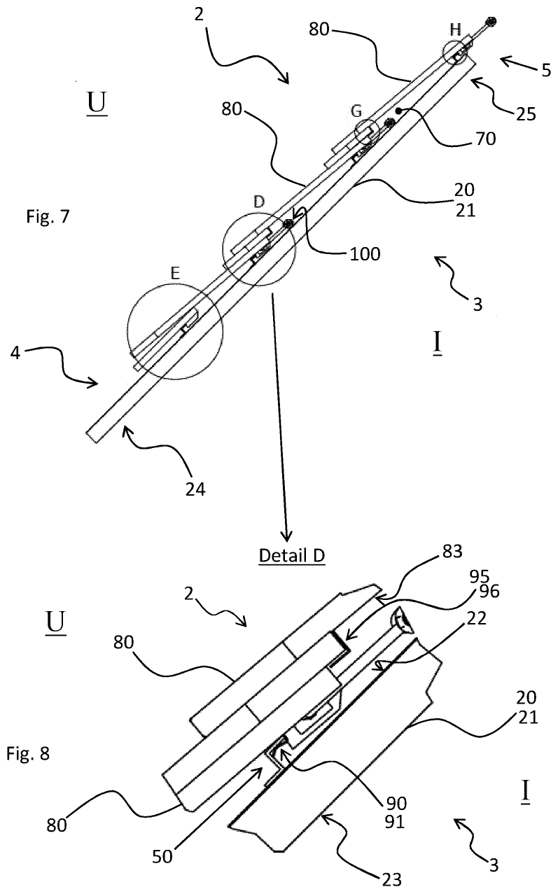

FIG. 1 shows a diagrammatic oblique perspective view of a section of a multifunctional roof covering 1 according to the present disclosure. The outer side of roof covering 1 is formed in the illustrated section by twelve solar roof tiles 80. Solar roof tiles 80 are provided on the outside with a glass stack, in which PV elements are in turn integrated for obtaining electric current from solar radiation. The outer shape and the outer appearance of solar roof tiles 80 correspond to those of standard roof tiles, in the illustrated example of embodiment of FIG. 1 (and FIGS. 2 to 5) to the appearance of flat tiles, for which reason these solar roof tiles 80 can also be referred to as solar flat tiles. In the example of embodiment shown in FIG. 6 (as well as in the illustrations of FIG. 7, FIG. 8 and FIG. 10), no solar flats tiles are however provided, but rather a solar roof tile 80 modelled on a roof tile in the plain tile design, which solar roof tiles 80 can therefore also be referred to as solar plain roof tiles.

In FIG. 1, the twelve solar roof tiles 80 are arranged in the section shown in four vertically adjacent rows each with three solar roof tiles 80 laterally adjacent in the horizontal direction. FIG. 6 (or FIG. 7) however shows in the section represented, in principle, fifteen solar roof tiles 80, arranged in three vertically adjacent rows each with five adjacent solar roof tiles 80 in the horizontal direction.

On account of the analogous properties with respect to multifunctional roof covering 1, therefore, the following description at the same time serves both to understand the embodiment of the roof covering 1 with flat solar tiles or, alternatively, solar plain roof tiles shown in FIG. 1 and following as well as in FIG. 6 and following, wherein details of the embodiment of FIG. 6 will be dealt with again later.

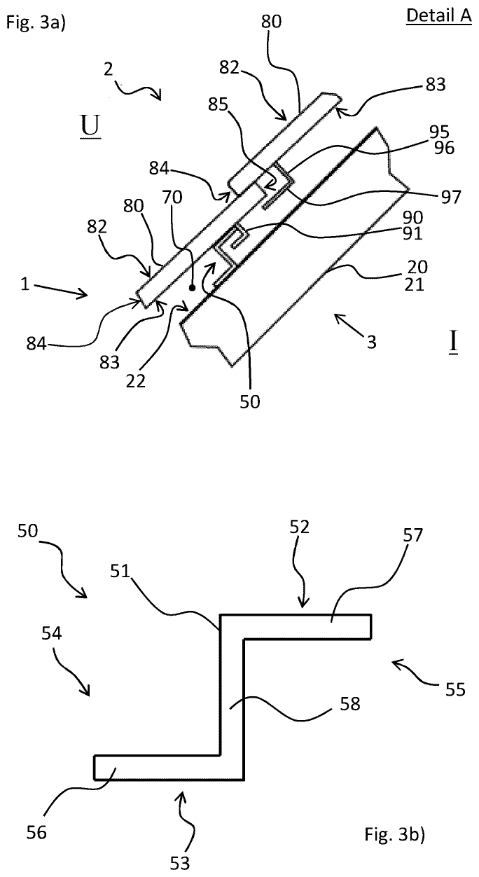

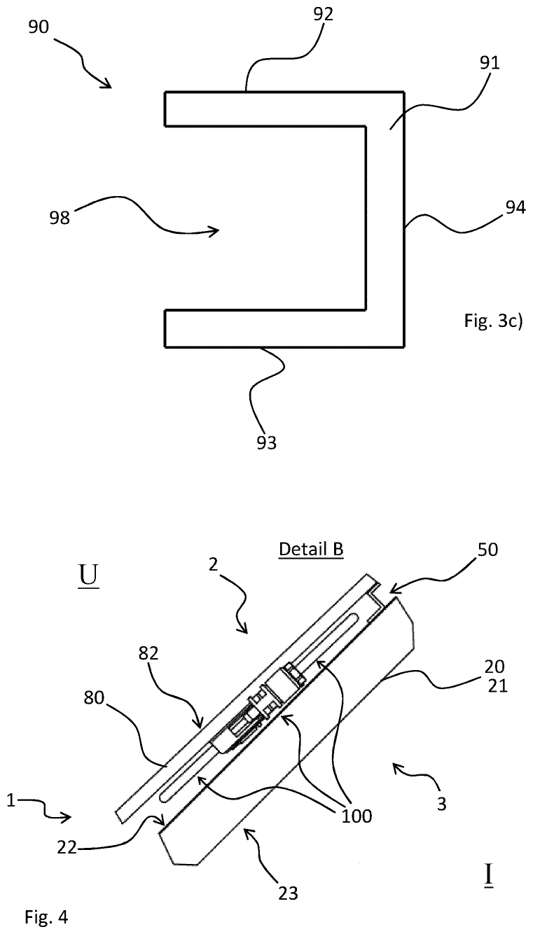

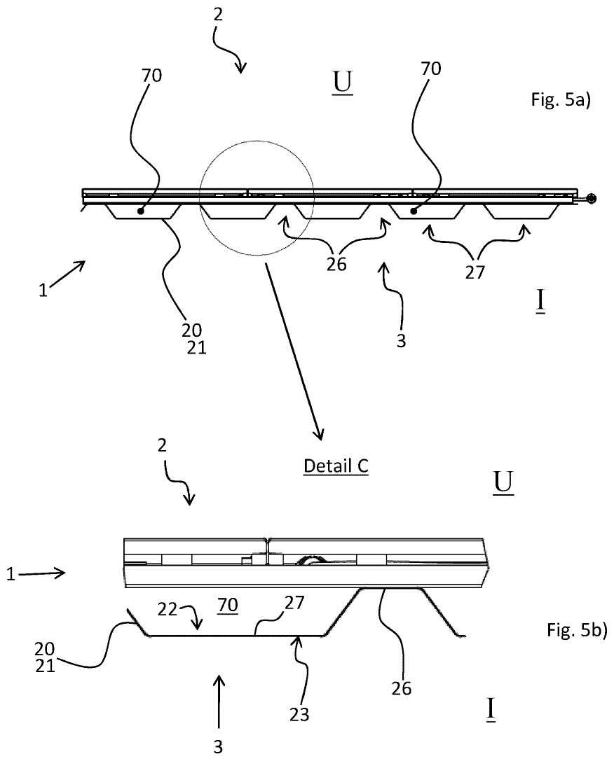

In the following, reference is made to FIG. 1 and also to FIG. 2, FIG. 3, FIG. 4 and FIG. 5. A roof eaves-side end 4 and an opposite roof ridge-side end 5 can be assigned to roof covering 1. In principle, the entire roof, in particular a sloping roof, can be covered with the proposed roof covering 1. Roof eaves-side end 4 then ends in the roof eaves arranged at the bottom of the roof, while the roof ridge-side end 5 corresponds to the roof ridge.

A dimensionally stable, sheet-like body 20 in the form of a trapezoidal sheet 21 is provided as the underside of roof covering 1, which represents inner side 3. Trapezoidal sheet 21 is applied to the roof skin for the water-repellent sealing of the roof skin. The roof is thus sealed. Multifunctional roof covering 1 can in principle also be provided additionally on existing roofs which are covered with a trapezoidal sheet 21.

For this purpose, trapezoidal sheet 21 is mounted on the roof skin or the sarking membrane. The construction of the roof lying beneath trapezoidal sheet 21 can correspond to a standard roof structure, for example with rafters, roofing underlay, battens, counter-battens. As a result of trapezoidal sheet 21, on the one hand a water tightness of the roof is achieved. On the other hand a high degree of fire safety is also ensured.

Trapezoidal sheet 21 can be formed from aluminium or also sheet steel. In the present preferred example of embodiment, the trapezoidal sheet has a thickness of 0.75 mm.

In addition to providing a waterproof outer skin, trapezoidal sheet 21 also ensures an unequivocal separation in the form of an independent separating body between solar roof tile 80 lying on outer side 2 and the elements of the roof (roof skin or sarking membrane or suchlike) which are further connected to inner side 3. As a result, cabling 100 of solar roof tiles 80 does not, for instance, have to be specifically attached, for example held, to solar roof tile inner sides 83. On the contrary, cabling 100 can advantageously simply rest on trapezoidal sheet 21, specifically on body outer side 22 of dimensionally stable, sheet-like body 20, which is otherwise not the case with solar roof tiles sealing a roof skin or sarking membrane of a roof, since laying of the cabling and plugs directly on the roof skin or sarking membrane is too dangerous or not even permissible due to legal requirements.

Trapezoidal sheet 21 also serves as a parting plane for the separation of electrical contacts, such as for example cabling 100 or plugs of solar roof tiles 80 to the roof skin or sarking membrane lying under roof covering 1.

Trapezoidal sheet 21 or dimensionally stable, sheet-like body 20 comprises a body outer side 22, in principle facing the outer surroundings U in the assembled state of roof covering 1, and also an opposite body inner side 23 which faces interior 1 of the building. Body inner side 23 rests on the basic structure (such as the roof skin) present under the proposed roof covering 1 and is securely attached thereto.

Trapezoidal sheet 21 comprises elevations 26 which extend from a roof eaves-side body end 24 to a roof ridge-side body end 25. In the present case, the respective ends of the illustrated section of trapezoidal sheet 21 are denoted by reference numbers 24 and 25. On a sloping roof, roof covering 21 and accordingly also trapezoidal sheet 21 extend farther in the upward direction towards the roof ridge and farther in the downward direction towards the roof eaves. Elevations 26 can then also extend farther upwards or downwards. In principle, it is also conceivable that elevations 26 do not extend completely from the roof eaves as far as the roof ridge or are also on occasion interrupted and thus not formed continuously. A depression 27 is formed in each case between two adjacent elevations 26.

Flow channels are formed by depressions 27, as a result of which an air duct can arise, specifically from the roof eaves to the roof ridge. Air flow L is indicated by the dashed arrow in FIG. 1 and also in FIG. 6. Air flow L that forms can serve on the one hand for cooling solar roof tiles 80 or PV units or, in some circumstances, standard roof tiles arranged adjacent: on the other hand the heat correspondingly absorbed by air flow L up to the roof ridge can also be provided and used as thermal energy. For example, in subsequent processes for energy use in the house. An example can be the installation of heat pumps, also for providing heating energy, wherein corresponding heated air of air flow L can be supplied to the heat pump.

The space provided by depressions 27 between body outer side 22 and solar roof tile inner side 83 can also be used to form cabling 100 of adjacent solar roof tiles 80.

Reference number 70 denotes cavity 70, which can be used to form air flow L and to form cabling 100.

The embodiments for roof covering 1 made in respect of the illustrated and previously described examples of embodiment can also be transferred to a façade cladding. Thus, illustrated dimensionally stable body 20, preferably in sheet-like, can also be mounted on a façade of a building, for example in the form of trapezoidal sheet 21. This body 20 can then also ensure the water tightness on the façade , and also increased fire protection, and also serve as a parting plane, so that the PV elements which follow further outwards on dimensionally stable body 20 are also reliably separated. In this regard, façade cladding 1 is then provided instead of a roof covering 1. The upper end is then meant by all the roof ridge-side ends (also the subsequently described body ends, attachment unit ends, solar roof tile ends). Top-side relates, when looking at the corresponding building, to the vertically upward lying region of the respective element on the building façade. The underside end is then meant by all the roof eaves-side ends (also the body ends described later, attachment unit ends, solar roof tile ends). Underside then relates, when looking at the corresponding building, to the vertically lower-lying region of the respective element on the building façade . Instead of a solar roof tile 80, a solar element 80 is generally referred to with regard to the façade . Insofar as the occupancy of a roof with solar roof tiles 80 is referred to below, this information can also be transferred to the cladding of a façade of a building with solar elements.

With regard to trapezoidal sheet 21, it is also possible for it not to be a sheet metal as a dimensionally stable body 20, but rather just another dimensionally stable metallic body. Instead of a typical continuous trapezoidal sheet 21 (which is usually to be screwed tight in large, sometimes also in a plurality of small formats on the existing roof skin, specifically as a rule on the battens), a so-called folded sheet metal can also be used. The basic geometry with elevations 26 and depressions 27 is then analogous. In the case of the folded metal sheet, however, metallic holders are screwed tight onto the roof truss (or the existing façade structure) and then the folded metal plate is inserted into the holders. The folded metal sheet is then simply screwed onto the roof ridge (or to a façade in the upper region), so that there are virtually no longer any penetrations on the entire roof surface or also façade surface, compared with the mounting of a trapezoidal sheet to be screwed tight. Both types of dimensionally stable, sheet-like bodies 20, for example trapezoidal sheet 21 or also described folded metal sheet, can be used in the present case. The following description of the properties of trapezoidal sheet 21 can also be transferred to the use of a folded metal sheet, in particular with regard to the geometry and the attachment of components lying farther to the exterior (attachment unit, solar roof tile or solar element, etc.), even when trapezoidal sheet 21 is referred to below.

A plurality of attachment units 50 are mounted on elevations 26 of trapezoidal sheet 21 in the form of Z-profiles 51. Z-profiles 51 run obliquely as a kind of obliquely running additional roof batten. In the present case, Z-profiles 51 are formed from aluminium as aluminium profiles. Z-profiles 51 lie with their attachment unit inner side 53 in the form of the respective inner legs 56 (see FIG. 3b)) on body outer side 22 (elevations 26). Z-profiles 51 are firmly riveted to trapezoidal sheet 21. In addition or alternatively, Z-profiles 51 can also be screwed to underlying roof battens of the roof.

From inner leg 56, Z-profile 51 extends with a connecting section 58 up to an attachment unit outer side 52 spaced apart from the attachment unit inner side 53. Attachment unit outer side 52 is in turn formed by outer leg 57.

For covering the roof with solar roof tiles 80, rear hook portions 90 in turn engage in attachment units 50 (Z-profile 51). In the present case, hook portions 90 are formed as a U-profile 91 and provided on solar roof tile inner side 83, specifically in the region of roof eaves-side solar roof tile end 84.

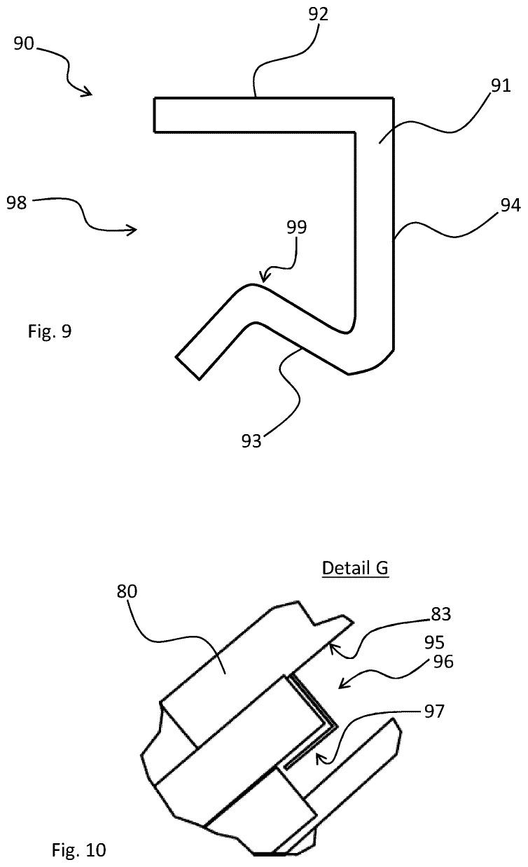

U-profiles 91 are attached with outer leg 92 to solar roof tile 80 underneath. A connecting section 94 of U-profile 91 then spaces apart inner leg 93 of U-profile 91 lying farther in the direction of trapezoidal sheet 21 (see FIG. 3c) or FIG. 9). A receptacle 98 is formed by U-profile 91. Receptacle 98 is open in the direction of roof eaves-side solar roof tile end 84. With this open side, receptacle 98 and thus U-profile 91 encloses outer leg 57 of attachment unit 50. As a result, a form-fitting connection of solar roof tiles 80 to attachment unit 50 and thus also to trapezoidal sheet 21 is achieved.

Furthermore, a rear retaining lug 95 can also be provided on solar roof tile inner side 83, specifically in the present case in a region of roof ridge-side solar roof tile end 85, in order to reinforce the stable connection of solar roof tiles 80. In the present case, this rear retaining lug 95 is also designed as a U-profile 96. With the underside 97, retaining lug 95 engages around a solar roof tile inner side 83 of an underlying adjacent solar roof tile 80.

In this way, effective storm suction protection is achieved. In the lower region of roof eaves-side solar roof tile end 84, rear hook portions 90 of a solar roof tile 80 hook onto Z-profiles 51, i.e. the transversely extending additional roof batten, while in the upper region of the roof ridge-side solar roof tile end 85 rear retaining lugs 95 of this solar roof tile 80 hook into underlying adjacent solar roof tiles 80.

In the present case, both U-profiles 91, 96 as well as Z-profile 51 are formed from aluminium.

Via the contacting elements in the form of rear hook portions 90, as well as the attachment sections 50 with trapezoidal sheet 21 connected thereto, a potential equalisation can advantageously also easily be implemented. A lightning discharge can also be enabled in a targeted manner by a suitable material selection and a secure continuous contact.

According to the embodiment of rear hook portion 90 shown in detail in FIG. 9, particularly secure contacting of the individual components, in particular of U-profile 91 and Z-profile 51, is possible and thus an improved storm suction protection and also a secure potential equalisation is possible. For this purpose, U-profile 91 of rear hook portion 90 according to FIG. 9 comprises an elevation 99 on inner leg 93, which elevation 99 extends farther up than a lower end of connecting section 94. In corresponding receptacle 98 of rear hook portion 90 shown in FIG. 9, outer leg 57 must therefore be introduced with greater force during the assembly of corresponding solar roof tiles 80. Or since the assembly process is reversed, i.e. solar roof tile 80 with rear hook portion 90 and receptacle 98 together with elevation 99 must be actively brought into engagement with outer leg 57 of Z-profile 51, a greater force must be employed for this purpose. Rear hook portion 90 and attachment unit 50 are thus not only brought into a form-fitting engagement with one another, but even into a force-fitting engagement in the form of a clamping seat. The contacting between the two units is thus firmer and safer, as a result of which the potential equalisation achieved as well as the storm suction protection achieved are also safer.

FIG. 6, FIG. 7, FIG. 8 and FIG. 10 show, as mentioned, roof covering 1 according to the present disclosure, with the difference that solar plain roof tiles instead of solar flat tiles are used as solar roof tiles 80. In this respect, reference can be made essentially to the above description of the example of embodiment according to FIGS. 1 to 5. Only the special features of roof covering 1 in the plain tile design, i.e. with solar roof tiles 80 in the form of solar plain roof tiles, are explained below.

Crown cover elements 81 are provided, which advantageously do not have to have a complete extension, such as the corresponding solar plain roof tiles. Crown cover elements 81 have a considerably shorter longitudinal extension. In particular, the storm suction protection, as described above, can be carried out without special involvement of crown covering elements 81.

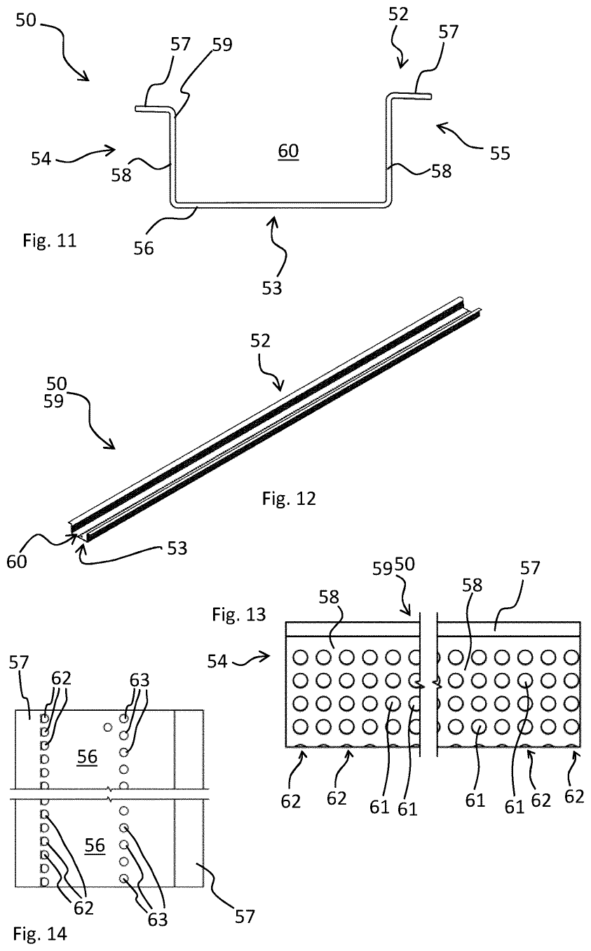

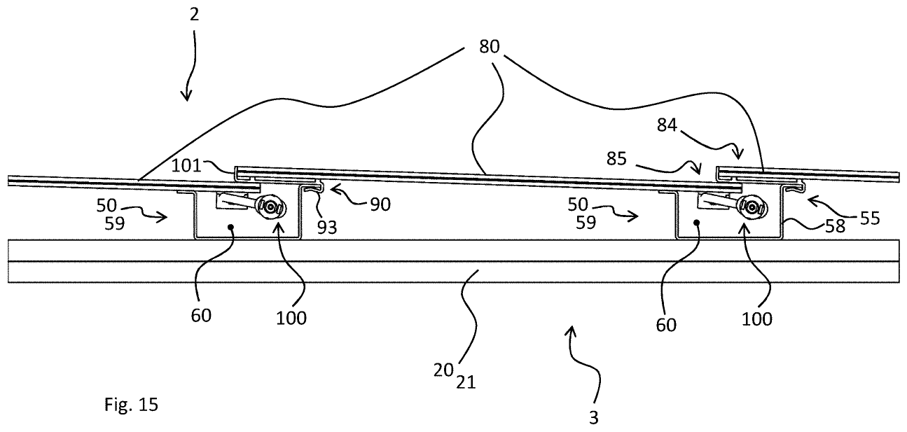

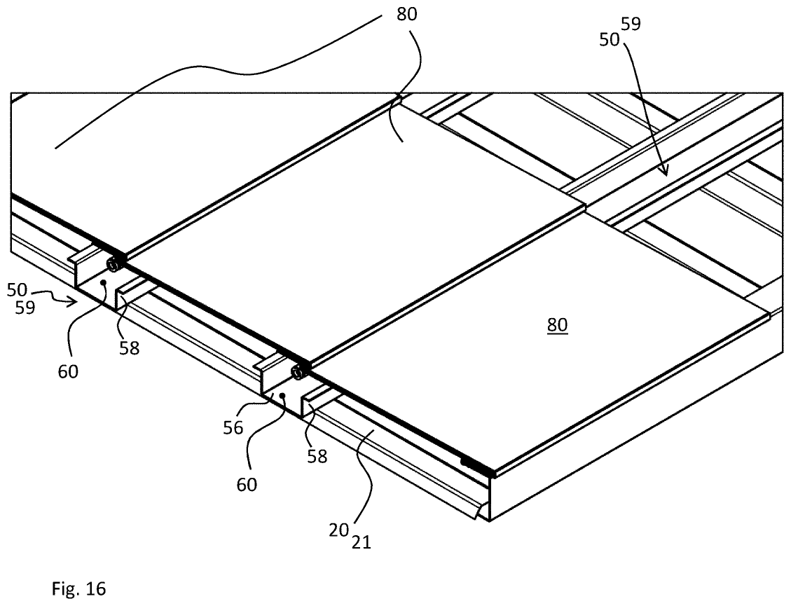

FIGS. 11 to 14 show a further embodiment of an attachment unit 50 in various illustrations. This can also be used in the previously described roof covering 1 or façade cladding 1 according to the preceding figures, as an alternative to the Z-profile 51, shown and described in the context of the preceding figures. In the case of the attachment unit according to FIGS. 11 to 14, which moreover is shown in use in a roof covering 1 or façade cladding 1 in FIGS. 15 and 16, it is a top-hat rail 59.

Top-hat rail 59 is also metallic, for example made of aluminium. It can also be a plate, preferably a perforated plate, bent or folded over to the corresponding cross section (see FIG. 11). When used as a perforated plate, material and weight can be saved on the one hand and on the other hand the holes can perform various functions in a targeted manner, as will be described later.

As can be seen from the cross-section in FIG. 11, top-hat rail 59, in comparison with the other embodiment of attachment unit 50 of Z-profile 51, is formed as it were in a double-Z shape, better described as a hat shape. The top of the hat shape represents the underside of top-hat rail 59. Accordingly, top-hat rail 59 comprises an attachment unit outer side 52 facing the following solar elements 80 or solar roof tiles 80, as well as an opposite attachment unit inner side 53 facing dimensionally stable, preferably sheet-like body 20. Attachment unit inner side 53 is formed by an inner leg 56, from which two connecting sections 58 (instead of only one connecting section 58 in Z-profile 51) extend upwards in the direction of attachment unit outer side 52. Furthermore, top-hat rail 59 comprises two outer legs 57 (instead of only one outer leg 57 in Z-profile 51). Outer legs 57 once again form on attachment unit outer side 52 support surfaces or attachment points for solar elements 80 or solar roof tiles 80 lying thereon in the final assembly state on the roof or on the façade . In order to distinguish between the respective two connecting sections 58 and outer legs 57, they can each be referred to regarding their use as connecting section 58 and outer leg 57 on roof eaves-side and/or underside attachment unit end 54 (on the left in FIG. 11) or as connecting section 58 and outer leg 57 on roof ridge-side or top-side attachment unit end 55 (on the right in FIG. 11).

In the assembled state with positioned solar elements or solar roof tiles 80, top-hat 59 ensures that those solar elements or solar roof tiles 80 are spaced apart from dimensionally stable body 50 (trapezoidal sheet 51 or folded metal sheet) arranged below top-hat rail 59. The air ducts for air flow L can thus be formed again. Due to its geometry, top-hat rail 59 already ensures an overlapping arrangement of the solar elements or solar roof tiles 80. Thus, connecting section 58 at roof ridge-side or topside attachment unit end 55 is longer than that at roof eaves-side or underside attachment unit end 54. As a result, solar element or solar roof tile 80, which is adjacent above when viewed vertically, is spaced farther apart from the roof skin or dimensionally stable body 20, so that upper solar element or solar roof tile 80, as seen vertically, rests with its lower end (roof eaves-side solar roof tile end 84 or underside solar element end 84) on the upper end of, viewed vertically, the underlying adjacent solar element or solar roof tile 80 (i.e. on its roof ridge-side solar roof tile end 85 or top-side solar element end 85) (see also FIGS. 15 and 16).

Furthermore, the (smaller) angle between the two legs present at roof eaves-side solar roof tile end 84 or underside solar element end 84 in the form of connecting section 58 present there or outer leg 58 is slightly larger than 90°. Preferably, the angle there (i.e. on the shorter of the two connecting sections 58) amounts to between 90.1° and 95.0°, particularly preferably between 91.5° and 92.0°. In contrast thereto, the (smaller) angle between the two legs present at roof ridge-side solar roof tile end 85 and respectively top-side solar element end 85 in the form of connecting section 58 present there and outer leg 58 is less than 90°. Preferably, the angle there (i.e. on the longer of the two connecting sections 58) amounts to between 89.9° and 86.0°, particularly preferably between 87.5° and 88.5°.

The distance between the two connecting sections 58, and the length of inner leg 56 in each direction, amounts to between 60 mm and 100 mm, preferably between 75 mm and 85 mm. The length of the shorter connecting section 58, as seen in the direction from inner leg 56 to outer leg 57, amounts to between 25 mm and 55 mm, preferably between 30 mm and 40 mm. The length of longer connecting section 58, as seen in the direction from inner leg 56 to outer leg 57, amounts to between 30 mm and 60 mm, preferably between 35 mm and 45 mm. The two outer legs 57, which form the support surfaces or attachment points for solar elements or solar roof tiles 80 arranged above, can likewise be of different lengths, measured along their longitudinal extension away from respective connecting section 58 to the side. Outer leg 58 adjoining longer connecting section 58 is preferably longer than outer leg 58 adjoining shorter connecting section 58. The length of longer outer leg 57 amounts to between 8 mm and 25 mm, preferably between 13 mm and 17 mm. The length of shorter outer leg 57 amounts to between 6 mm and 20 mm, preferably between 10 mm and 15 mm.

Top-hat rail 59 comprises various holes which perform various functions. On the one hand, through-ventilation openings 61 are provided, specifically in connecting section 58, as a result of which the air flow can also be guided over and through top-hat rails 59. Furthermore, discharge openings 62 are provided in the lower corner between inner leg 56 and adjacent connecting section 58 below, through which water (e.g. rainwater) penetrating into cavity 60 and accumulating there can run off. Furthermore, there are also assembly openings 63 in the region of inner leg 56, via which top-hat rail 59 can basically be installed on the underlying structure of the building, for example dimensionally stable body 20. The top-hat rail can be screwed or riveted for example to body 20.

FIG. 15 shows a roof covering or façade cladding 1, as is implemented with attachment units 50 designed as a top-hat rail 59. Top-hat rails 59 each provide a receiving space 60, in which cabling 100 can be safely run through and above all can be arranged separately from the sections of the building located farther inside.

Top-hat rail 59 is arranged in each case engaging over two adjacent solar elements/solar roof tiles 80. Accordingly, it supports both adjacent solar elements/solar roof tiles 80. In receiving space 60, sufficient free space is provided for underlying adjacent solar element/solar roof tile 80, so that the latter are displaced upward in the direction of the topside or roof ridge for the purpose of individual dismantling and in this way can be brought out of engagement with the attachment unit located there at its underside (roof eaves-side solar roof tile end 84; underside solar element end 84). The corresponding solar element/solar roof tile can then be pivoted out of the composite and pulled away downwards (if necessary after previous release of cabling). This process is also partly possible due to the fact that vertically adjacent solar elements/solar roof tiles 80 are arranged overlapping and not abutting for example.

FIG. 16 again shows in a partial detail the interaction of three vertically adjacent solar roof tiles 80 and top-hat rails 59 and dimensionally stable body 20 lying beneath.

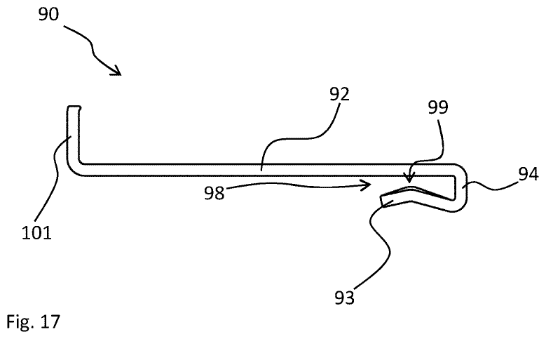

FIG. 17 shows a hook portion 90 separately in a side view. This hook portion 90 partially diverges from hook portion 90 shown and described in the context of FIGS. 1 to 10 in the form of U-profile 91 (in particular according to FIGS. 3c) or FIG. 9), wherein some properties can also be transferred from corresponding U-profiles 91 described above. Specifically, an outer leg 92 is also present, which is arranged or attached to solar roof tile inner side 83, as a result of which rear hook portion 90 is located beneath corresponding solar roof tile 80. Furthermore, a connecting section 94 and an inner leg 93 are also provided, which together form receptacle 98, which in turn provides for the engagement with attachment unit 50 (specifically its outer leg 57). An elevation 99 is also present, which provides for the clamping seat with attachment unit 50.

In other words, in the present case in FIG. 17, outer leg 92 extends as far as the underside solar element end or roof eaves-side solar roof tile end 84. Furthermore, a front leg 101 is then also provided adjoining the outer leg 92, which is bent over or projects in the direction of the outside. This front leg 101 is accordingly arranged on underside solar element end or roof eaves-side solar roof tile end 84 and engages around and protects the front surface of the solar element or solar roof tile located there. Front leg 101 extends as far as solar element outer side or solar roof tile outer side 82 and terminates there flush with solar element or solar roof tile 80. In this way, an edge protection for the glass stack of solar elements or solar roof tiles 80 is simultaneously ensured by front leg 101 engaging round.

1. A multifunctional building enclosure part, in particular a multifunctional roof covering for covering a roof of a building, wherein the multifunctional building envelope part, in particular the roof covering, comprises an outer side facing the surroundings and an inner side facing the interior of the building, wherein the inner side is designed as a dimensionally stable, preferably sheet-like, body for the water-repellent sealing of an outer skin enveloping the building, in particular a roof skin enveloping the building on the roof side, and for mounting on the outer skin, in particular the roof skin,
wherein the dimensionally stable, preferably sheet-like body comprises a body outer side facing in the direction of the surroundings and is designed for mounting on the outer skin, in particular roof skin, and wherein the dimensionally stable, preferably sheet-like body comprises at least two elevations extending further to the body outer side,
wherein at least one attachment unit with an attachment unit inner side is fixedly mounted on the at least two elevations on the body outer side, and wherein the attachment unit comprises an outer leg spaced apart from the attachment unit inner side in the direction of an attachment unit outer side and extending in the direction of a top-side, in particular roof ridge-side attachment unit end,
wherein the outer side is equipped uniformly with at least one solar element, in particular a solar roof tile, in such a way that the at least one solar element, in particular the at least one solar roof tile, in combination with other adjacent solar elements, in particular solar roof tiles, and/or adjacent standard plate elements, in particular roof tiles, forms the outer side of the building envelope part, in particular the roof covering, substantially in a common plane, in particular a tile plane, whereby the at least one solar element, in particular the at least one solar roof tile, engages behind the outer leg of the attachment unit with a rear hook portion in a form-fitting manner.

2. The multifunctional building enclosure part, in particular the multifunctional roof covering, according to claim 1, wherein a cavity is formed between the two elevations, in such a way that in the cavity an air flow flowing along in the direction of the top-side, in particular the roof ridge-side end and below a solar element inner side, in particular a solar roof tile inner side, is formed.

3. The multifunctional building enclosure part, in particular the multifunctional roof covering, according to claim 1, wherein the attachment unit is designed as a top-hat rail.

4. The multifunctional building enclosure part, in particular the multifunctional roof covering, according to claim 1, wherein the attachment unit comprises a further outer leg spaced apart from the attachment unit inner side in the direction of an attachment unit outer side, wherein this further outer leg extends in the direction of an underside, in particular a roof eaves-side attachment unit end.

5. The multifunctional building enclosure part, in particular the multifunctional roof covering, at least according to claims 4, wherein the outer leg extending in the direction of the top-side, in particular roof-ridge side, attachment unit end is spaced farther apart from the attachment unit inner side than the outer leg extending in the direction of the underside, in particular roof-eaves side, attachment unit end.

6. The multifunctional building enclosure part, in particular the multifunctional roof covering, according to claim 4, wherein a, viewed vertically, underlying adjacent solar element or plate element or a, viewed vertically, underlying adjacent solar roof tile or standard roof tile lies on the face, pointing in the direction of the attachment unit outer side, of the outer leg extending in the direction of the underside, in particular roof eaves-side attachment end.

7. The multifunctional building enclosure part, in particular the multifunctional roof covering, according to claim 1, wherein the attachment unit provides a receiving space between the inner leg and the at least one solar element, in particular the at least one solar roof tile, as well as vertically adjacent elements, wherein cabling of the at least one solar element, in particular of the at least one solar roof tile, and optionally at least one adjacent solar element, in particular solar roof tile can be arranged or is arranged in the receiving space.

8. The multifunctional building enclosure part, in particular the multifunctional roof covering, according to claim 1, wherein in one, preferably both connecting section, preferably connecting sections spacing the inner leg apart from the outer leg, preferably the outer legs, at least one through-ventilation opening is arranged for partially conducting the air flow.

9. The multifunctional building enclosure part, in particular the multifunctional roof covering, according to claim 1, wherein at least one outlet opening for draining water from a/the receiving space is provided in a transition region between the inner leg and a/the connecting section, which is assigned to a/the underside, preferably roof eaves-side attachment unit end.

10. The multifunctional building enclosure part, in particular the multifunctional roof covering, according to claim 1, wherein the attachment unit, as viewed in a vertical row of two adjacent solar elements, preferably solar roof tiles, is arranged engaging over the solar element/solar roof tile arranged below and the solar element/solar roof tile arranged above and beneath the two vertically adjacent solar elements/solar roof tiles,
and/or
wherein a/the solar element/solar roof tile arranged above with its underside solar element end or roof eaves-side solar roof tile end rests on a/the top-side solar element end or roof ridge-side solar roof tile end of a/the solar element/solar roof tile arranged below.

11. The multifunctional building enclosure part, in particular the multifunctional roof covering, according to claim 1, wherein the rear hook portion comprises an outer leg extending as far as a/the underside solar element end, in particular the roof eaves-side solar roof tile end.

12. The multifunctional building enclosure part, in particular the multifunctional roof covering, according to claim 1, wherein the rear hook portion comprises a front leg which engages around and protects a front surface of the solar element, in particular solar roof tile, which front surface is arranged on a/the underside solar element end, in particular a roof eaves-side solar roof tile end, said front leg preferably terminating on a/the solar element outer side, in particular a solar roof tile outer side, flush with the solar element, in particular solar roof tile.

13. A method for cladding a building, in particular for covering a roof of a building, with at least one solar element, in particular solar roof tile, and for providing a multifunctional roof enclosure part, in particular a multifunctional roof covering, in particular according to claim 1, with the following steps:
a) providing an inner side of the building enclosure part facing the interior of the building, in particular the roof covering, as a dimensionally stable, preferably sheet-like like body for the water-repellent sealing of an outer skin enveloping the building, in particular a roof skin enveloping the building on the roof side, and thus providing a body outer side facing in the direction of the surroundings and at least two elevations of the dimensionally stable, preferably sheet-like body which extend farther towards the body outer side;
b) mounting at least one attachment unit on the body outer side of the dimensionally stable, preferably sheet-like like body, by fixedly mounting an attachment unit inner side on the at least two elevations, and thereby providing an outer leg of the attachment unit, which is spaced apart from the attachment unit inner side in the direction of the attachment unit outer side and extends in the direction of a top-side, in particular roof ridge-side attachment unit end; and
c) cladding the outer enclosure with the at least one solar element, in particular covering the roof with the least one solar roof tile, whereby the at least one solar element, in particular the at least one solar roof tile engages behind the outer leg of the attachment unit with a rear hook portion in a form-fitting manner and the at least one solar element, in particular the at least one solar roof tile, in combination with further adjacent solar elements, in particular solar roof tiles, and/or adjacent standard plate elements, in particular roof tiles, form an outer side of the building enclosure part, in particular the roof covering essentially uniformly in a common plane, in particular a tile plane.

14. A method for dismantling a single solar element to be dismantled, preferably a solar roof tile, from a composite of at least vertically adjacent solar elements, in particular solar roof tiles, wherein the single solar element to be dismantled, preferably solar roof tile, is first displaced partially upwards in the direction of the building roof or roof ridge, preferably in that the top-side solar element end, in particular the roof ridge-side solar roof tile end, is displaced upwards, in a free space below the solar element, preferably solar roof tile, and a rear hook portion is thereby brought out of engagement with an attachment unit, wherein an underside solar element end, in particular a roof eaves-side solar roof tile end, is then pivoted forward away from the composite and the single solar element to be dismantled, preferably solar roof tile, is pulled away downwards and thus released from the composite, wherein where necessary cabling is released beforehand.

15. An under-roof construction or façade substructure for the water repellent sealing of a roof skin enveloping a building on the roof side or outer skin enveloping a building at the sides, and for providing at least one attachment unit for mounting at least one solar roof tile or solar element, wherein the under-roof construction or façade substructure comprises a dimensionally stable, preferably sheet-like body for the water-repellent sealing of the roof skin or outer skin, and wherein the under-roof construction or façade substructure comprises the attachment unit,
wherein the dimensionally stable, preferably sheet-like body comprises a body outer side pointing in the direction of the surroundings and is designed to be mounted on the roof skin or outer skin, and wherein the dimensionally stable, preferably sheet-like body comprises at least two elevations extending farther to the body outer side,
wherein the attachment unit is fixedly mounted with an attachment unit inner side on the at least two elevations on the body outer side and
wherein the attachment unit comprises an outer leg, which is spaced apart from the attachment unit inner side in the direction of an attachment unit outer side and extends in the direction of a roof ridge-side or top-side attachment unit end, for the form-fitting connection of at least one solar roof tile or solar element.

16. A method for providing a roof of a building for covering with at least one solar roof tile or a façade of a building for cladding with at least one solar element, in particular for providing an under-roof construction or façade substructure, in particular for providing a multifunctional building enclosure part or a multifunctional roof covering according to claim 1, with the following steps:
a) applying a dimensionally stable, preferably sheet-like body for water-repellent sealing on an outer skin enveloping the building, in particular a roof skin enveloping the building on the roof side, and thereby providing a body outer side facing in the direction of the surroundings and at least two elevations of the dimensionally stable, preferably sheet-like body extending further to the body outer side; and
b) mounting at least one attachment unit on the body outer side of the dimensionally stable, preferably sheet-like body, by mounting an attachment unit inner side fixedly on the at least two elevations, and thereby providing an outer leg of the attachment unit, which is spaced apart from the attachment unit inner side in the direction of attachment unit outer side and extends in the direction of a top-side, in particular roof ridge-side attachment unit end, for the form-fitting connection of at least one solar element, in particular solar roof tile by engaging with a rear hook portion of the at least one solar element, in particular solar roof tile.

17. A multifunctional building envelope part, in particular a multifunctional roof covering for covering a roof of a building or a multifunctional façade cladding, wherein the multifunctional building envelope part, in particular the roof covering or façade cladding, comprises an outer side facing the surroundings and an inner side facing the interior of the building, wherein at least one attachment unit with an attachment unit inner side is fixedly mounted on an outer skin enveloping the building, in particular a roof skin enveloping the building on the roof side, or a lateral outer skin of the building, and wherein the attachment unit comprises an outer leg which is spaced apart from the attachment unit inner side in the direction of an attachment unit outer side and extends in the direction of a top-side, in particular roof-ridge side, attachment unit end,
wherein the outer side is uniformly equipped with at least one solar element, in particular a solar roof tile, in such a way that the at least one solar element, in particular the at least one solar roof tile, in combination with further adjacent solar elements, in particular solar roof tiles, and/or adjacent standard plate elements, in particular roof tiles, forms the outer side of the building envelope part, in particular the roof covering or façade cladding, substantially in a common plane, whereby the at least one solar element, in particular the at least one solar roof tile, engages behind the outer leg of the attachment unit in a form-fitting manner with a rear hook portion, wherein the attachment unit between an inner leg (56) and the at least one solar element, in particular the at least one solar roof tile, and a vertically adjacent solar element, in particular solar roof tile, provides a receiving space, wherein cabling of the at least one solar element, in particular of the at least one solar roof tile, and optionally at least one adjacent solar element, in particular solar roof tile, can be or is arranged separately from the outer skin, in particular roof skin or a lateral outer skin of the building.
